(19) United States
(12) Patent Application Publication
(10) Pub. No.: US 2011/0286715 A1
(43) Pub. Date: Nov. 24, 2011

(54) METHOD FOR PROVIDING A VIDEO PLAYBACK DEVICE WITH A SUBTITLE-BASED REPEAT/PLAYBACK FUNCTION, AND ASSOCIATED VIDEO PLAYBACK DEVICE AND ASSOCIATED PROCESSING CIRCUIT

(76) Inventors: Yong Zhang, Anhui Province (CN); Ping Zhao, Anhui Province (CN)

(21) Appl. No.: 12/809,069

(22) PCT Filed: May 19, 2010
(86) PCT No.: PCT/CN10/72938

§ 371 Date: Jun. 18, 2010

(51) Int. Cl. H04N 9/80; H04N 5/775

(52) U.S. Cl. 386/230; 386/243; 386/E09.011; 386/E05.07

(57) ABSTRACT

A method for providing a video playback device with a subtitle-based repeat/playback function includes: storing at least one subtitle start time point corresponding to at least one subtitle; and providing the video playback device with a user interface for controlling the video playback device to perform at least one predetermined operation according to the at least one subtitle start time point in response to at least one predetermined user control activity. An associated video playback device and an associated processing circuit are provided. In particular, the processing circuit includes: a controller arranged to control operations of the video playback device; and a program code embedded in the controller or received from outside the controller, where the controller executing the program code is arranged to provide the user interface of the subtitle-based repeat/playback function for controlling the video playback device to perform the at least one predetermined operation.

### TECHNICAL FIELD

The present invention relates to repeat/playback control of a video playback device, and more particularly, to a method for providing a video playback device with a subtitle-based repeat/playback function, and to an associated video playback device and an associated processing circuit.

### BACKGROUND

When a user is viewing a foreign program using a conventional video playback device such as a digital versatile disc (DVD) player or a Blu-ray Disc (BD) player, there may be an opportunity for the user to learn the foreign language utilized in the foreign program. In a situation where the foreign program is of a specific type that the user prefers, the user may enjoy learning the foreign language by repeatedly viewing the foreign program.

Typically, when the user is viewing the foreign program, the conventional video playback device implemented according to the related art merely displays subtitles such as dialogues that are superimposed on the bottom of the screen, causing many problems of using the conventional video playback device. For example, the user cannot concentrate his/her attention on sentences or words of unfamiliar meanings, where the user may need to spend his/her time on reviewing these sentences or words. In another example, given that the user is a basic learner of the foreign language, when the user misses the meaning of a sentence or a word (e.g. a sentence or a word that is probably too difficult for a basic learner), the user may be forced to stop viewing the foreign program in order to figure out what the meaning is. If the user does not stop viewing the foreign program to figure out what the meaning is, he/she may have to search though out the foreign program later in order to find out the sentence or the word.

In conclusion, the conventional video playback device does not serve the user well. Thus, a novel method is required for enhancing the viewing experience of the user.

### SUMMARY

It is therefore an objective of the claimed invention to provide a method for providing a video playback device with a subtitle-based repeat/playback function, and to provide an associated video playback device and an associated processing circuit, in order to solve the above-mentioned problems.

An exemplary embodiment of a method for providing a video playback device with a subtitle-based repeat/playback function comprises: storing at least one subtitle start time point corresponding to at least one subtitle; and providing the video playback device with a user interface for controlling the video playback device to perform at least one predetermined operation according to the at least one subtitle start time point in response to at least one predetermined user control activity.

An exemplary embodiment of an associated video playback device provided with a subtitle-based repeat/playback function comprises at least one storage unit/module and a processing circuit. The storage unit/module is arranged to store information. The processing circuit is arranged to store at least one subtitle start time point corresponding to at least one subtitle into the storage unit/module. In addition, the processing circuit is further arranged to provide the video playback device with a user interface for controlling the video playback device to perform at least one predetermined operation according to the at least one subtitle start time point in response to at least one predetermined user control activity. Additionally, the storage unit/module is embedded in the processing circuit or positioned outside the processing circuit.

An exemplary embodiment of an associated processing circuit for controlling a video playback device and providing the video playback device with a subtitle-based repeat/playback function comprises: a controller arranged to control operations of the video playback device; and a program code embedded in the controller or received from outside the controller. In addition, the controller executing the program code is arranged to store at least one subtitle start time point corresponding to at least one subtitle into at least one storage unit/module within the video playback device. Additionally, the controller executing the program code is further arranged to provide the video playback device with a user interface for controlling the video playback device to perform at least one predetermined operation according to the at least one subtitle start time point in response to at least one predetermined user control activity.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a video playback device provided with a subtitle-based repeat/playback function according to a first embodiment of the present invention.

FIG. 2 is a flowchart of a method for providing a video playback device with a subtitle-based repeat/playback function according to an embodiment of the present invention.

FIG. 3A illustrates a screen displaying a subtitle and an associated video content that are involved in the method shown in FIG. 2 according to an embodiment of the present invention.

FIG. 3B illustrates a subtitle start time point and a subtitle end time point respectively corresponding to the subtitle shown in FIG. 3A.

FIG. 4 illustrates a plurality of subtitles and a plurality of subtitle start time points respectively corresponding to the subtitles according to an embodiment of the present invention, where this embodiment is a special case of the embodiment shown in FIG. 2.

FIG. 5A illustrates an exemplary user interface arrangement according to an embodiment of the present invention, where this embodiment is another special case of the embodiment shown in FIG. 2.

FIG. 5B illustrates a plurality of subtitle start time points, a plurality of subtitle end time points, and a plurality of text strings that are involved in the method shown in FIG. 2 according to the embodiment shown in FIG. 5A.

FIG. 6 is a diagram of a video playback device provided with a subtitle-based repeat/playback function according to a second embodiment of the present invention.

FIG. 7 is a diagram of a video playback device provided with a subtitle-based repeat/playback function according to a third embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

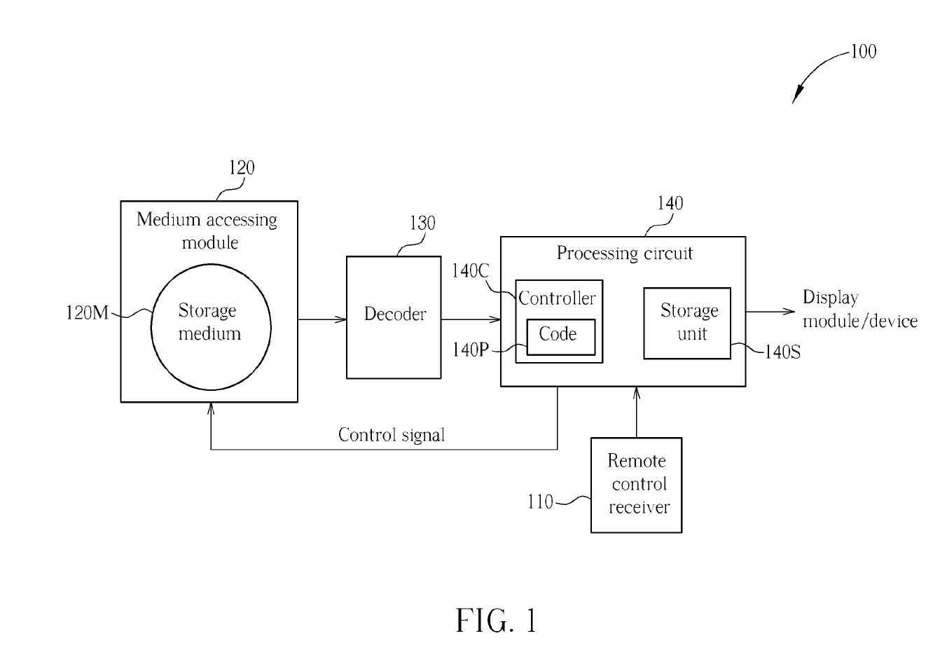

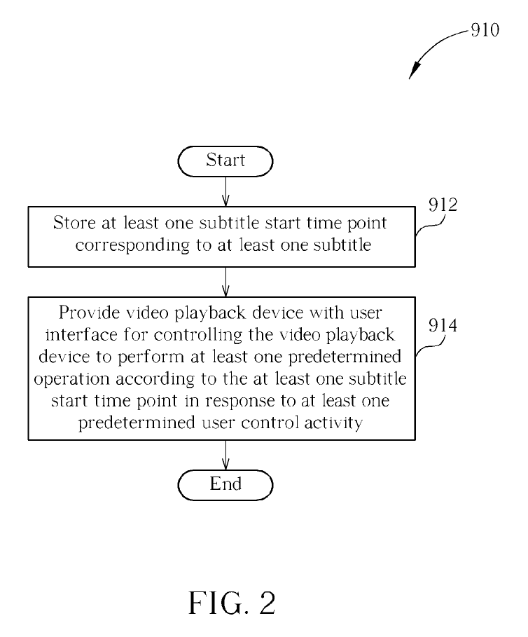

Please refer to FIG. 1, which illustrates a diagram of a video playback device 100 provided with a subtitle-based repeat/playback function according to a first embodiment of the present invention. The video playback device 100 comprises a remote control receiver 110, a medium accessing module 120, a decoder 130, and a processing circuit 140, where the processing circuit 140 comprises a controller 140C executing program code 140P (labeled “Code” in FIG. 2). For example, According to an aspect of this embodiment, the video playback device 100 may represent a digital versatile disc (DVD) player or a Blu-ray Disc (BD) player, and the processing circuit 140 may output processing results to a display device such as a monitor. In addition, the medium accessing module 120 can be an optical disc loader of the DVD player or the BD player. Additionally, the storage medium 120M accessed by the medium accessing module 120 can be a removable storage medium such as a DVD or a BD. This is for illustrative purposes only, and is not meant to be a limitation of the present invention. According to another aspect of this embodiment, the video playback device 100 may represent a TV such as a liquid crystal display (LCD) TV with the medium accessing module 120 being embedded therein, and the processing circuit 140 may output processing results to a display module of the LCD TV, such as an LCD panel. In addition, the medium accessing module 120 can be an optical disc loader of the LCD TV. Similarly, the storage medium 120M accessed by the medium accessing module 120 can be a removable storage medium such as a DVD or a BD.

As mentioned, the storage medium 120M accessed by the medium accessing module 120 can be a removable storage medium. This is for illustrative purposes only, and is not meant to be a limitation of the present invention. According to some variations of this embodiment, the storage medium 120M accessed by the medium accessing module 120 can be a storage medium embedded in the medium accessing module 120. For example, the medium accessing module 120 can be a Hard Disk Drive (HDD), where the storage medium 120M may represent a Hard Disk (HD) within the HDD. In another example, the medium accessing module 120 can be a Solid State Drive (SDD), where the storage medium 120M may represent at least one Flash memory within the SDD.

In this embodiment, the controller 140C can be a hardware controller with the program code 140P being embedded therein. This is for illustrative purposes only, and is not meant to be a limitation of the present invention. According to some variations of this embodiment, the controller 140C can be a micro control unit (MCU) or a micro processing unit (MPU), and the program code 140P may represent a program code received from outside the controller 140C. For example, the program code 140P can be firmware code stored in a memory within the processing circuit 140 or the video playback device 100 (e.g. the storage unit 140S of some embodiments, or a storage module such as those in some of the following embodiments). In another example, the program code 140P can be software code stored in a memory/storage module within the processing circuit 140 or the video playback device 100 (e.g. the storage unit 140S of some embodiments, or a storage module such as those in some of the following embodiments). Thus, whether a program code such as the program code 140P is stored in a memory/storage module such as any of those mentioned above depends on different variations of this embodiment.

According to this embodiment, the processing circuit 140 (and more particularly, the controller 140C executing the program code 140P) stores at least one subtitle start time point corresponding to at least one subtitle into at least one storage unit/module, where the storage unit/module can be embedded in the processing circuit 140 or positioned outside the processing circuit 140. Here, the storage unit 140S is taken as an example of the storage unit/module. In addition, the processing circuit 140 is arranged to provide the video playback device 100 with a user interface of the subtitle-based repeat/playback function for controlling the video playback device 100 to perform at least one predetermined operation (e.g. one or more subtitle-based repeat/playback operations) according to the at least one subtitle start time point mentioned above in response to at least one predetermined user control activity. Please note that the user interface may comprise at least one physical user interface (e.g. one or more buttons, keys, etc. of a remote controller of the video playback device 100, and/or one or more buttons, keys, etc. implemented on the shell of the video playback device 100) and/or at least one displayed user interface (e.g. one or more menus, items of a menu, one or more highlighted items, etc.) in this embodiment or variations thereof. This is for illustrative purposes only, and is not meant to be a limitation of the present invention. According to some variations of this embodiment, the user interface may comprise the above-mentioned at least one physical user interface, the above-mentioned displayed user interface, and/or at least one audio user interface, such as one or more microphones, earphones, speakers, audio input/output jacks, and so on.

More specifically, the processing circuit 140 is utilized for controlling the video playback device 100 and providing the video playback device 100 with the subtitle-based repeat/playback function. In practice, the controller 140C therein is arranged to control operations of the video playback device 100, where the video playback device 100 may output a control signal to control the medium accessing module 120, and further output another control signal (not shown) to control the decoder 130. The controller 140C executing the program code 140P is arranged to provide the video playback device 100 with the user interface of the subtitle-based repeat/playback function for controlling the video playback device 100 to perform the aforementioned at least one predetermined operation, in response to one or more predetermined user control activities. For example, when the user presses a predetermined key/button on a remote controller (not shown) of the video playback device 100, the remote control receiver 110 receives a remote control signal from the remote controller and therefore the processing circuit 140 detects such a predetermined user control activity. During playback of the program that the user is viewing (e.g. a program recorded on the storage medium 120M), the decoder 130 performs some decoding operations regarding the program, and the processing circuit 140 starts storing at least one subtitle start time point corresponding to at least one subtitle of the program into the storage unit/module (e.g. the storage unit 140S of some embodiments, or a storage module such as those in some of the following embodiments). In addition, when the user presses the same or another predetermined key/button on the remote controller (not shown), the remote control receiver 110 receives a remote control signal from the remote controller and therefore the processing circuit 140 detects such a predetermined user control activity, and then, the processing circuit 140 controls the video playback device 100 to perform the aforementioned at least one predetermined operation that may comprise jumping to the subtitle start time point and/or playing back starting from the subtitle start time point. This is for illustrative purposes only, and is not meant to be a limitation of the present invention. According to a variation of this embodiment, when the user presses a predetermined key/button on the remote controller (not shown), the remote control receiver 110 receives a remote control signal from the remote controller and therefore the processing circuit 140 detects such a predetermined user control activity. During playback of the program, the processing circuit 140 starts storing the aforementioned at least one subtitle start time point and at least one subtitle end time point corresponding to the aforementioned at least one subtitle into the storage unit/module (e.g. the storage unit 140S of some embodiments, or a storage module such as those in some of the following embodiments). In addition, when the user presses the same or another predetermined key/button on the remote controller (not shown), the remote control receiver 110 receives a remote control signal from the remote controller and therefore the processing circuit 140 detects such a predetermined user control activity, and then, the processing circuit 140 controls the video playback device 100 to perform the aforementioned at least one predetermined operation that may comprise jumping to the subtitle start time point and/or repeatedly playing back during an interval between the subtitle start time point and the subtitle end time point.

FIG. 2 is a flowchart of a method 910 for providing a video playback device with a subtitle-based repeat/playback function according to an embodiment of the present invention. The method 910 can be applied to the video playback device 100 shown in FIG. 1, and more particularly, the processing circuit 140 therein. In addition, the method 910 can be implemented by utilizing the video playback device 100 shown in FIG. 1, and more particularly, the processing circuit 140 therein. The method 910 is described as follows.

In Step 912, the processing circuit 140 (and more particularly, the controller 140C executing the program code 140P) stores at least one subtitle start time point corresponding to at least one subtitle into the aforementioned at least one storage unit/module such as the storage unit 140S. According to some special cases of this embodiment, the processing circuit 140 may further store other information, such as the aforementioned at least one subtitle end time point and/or at least one text string corresponding to the aforementioned at least one subtitle into the storage unit/module mentioned above. In practice, individual subtitle data of the program is typically available, and the processing circuit 140 may operate based upon the subtitle data of the above-mentioned at least one subtitle (e.g. one or more subtitles such as subtitles 24-1, 24-2, . . . , etc.). For example, in a situation where the individual subtitle data of the program is available, the processing circuit 140 may extract the at least one text string (e.g. one or more text strings such as text strings Str(1), Str(2), etc.) from the subtitle data of the above-mentioned at least one subtitle. In another example, in a situation where there is no individual subtitle data available (e.g. all subtitles are originally mixed into the video contents of the program), the processing circuit 140 may perform an optical character recognition (OCR) operation on the at least one subtitle (e.g. one or more subtitles such as subtitles 24-1, 24-2, etc.) to generate the at least one text string (e.g. one or more text strings such as text strings Str(1), Str(2), . . . , etc.).

More particularly, the processing circuit 140 may perform a translation operation on the at least one subtitle (e.g. one or more subtitles such as subtitles 24-1, 24-2, . . . , etc.) to generate the at least one text string (e.g. one or more text strings such as text strings Str(1), Str(2), . . . , etc.). For example, in a situation where the individual subtitle data of the program is available, the processing circuit 140 may extract an original version of the text string from the subtitle data mentioned above, and then perform the translation operation on the original version of the text string to generate a translated version of the text string as the final version to be stored into the storage unit/module mentioned above. In another example, in a situation where there is no individual subtitle data available, the processing circuit 140 may perform the OCR operation on the subtitle to generate an original version of the text string, and then perform the translation operation on the original version of the text string to generate a translated version of the text string as the final version to be stored into the storage unit/module mentioned above.

In Step 914, the processing circuit 140 (and more particularly, the controller 140C executing the program code 140P) provides the video playback device 100 with the user interface of the subtitle-based repeat/playback function for controlling the video playback device 100 to perform at least one predetermined operation (e.g. one or more subtitle-based repeat/playback operations) according to the above-mentioned at least one subtitle start time point in response to at least one predetermined user control activity, such as those disclosed above. In particular, the aforementioned at least one subtitle may comprise a plurality of subtitles, and the aforementioned at least one subtitle start time point may comprise a plurality of subtitle start time points respectively corresponding to the subtitles. Thus, the processing circuit 140 controls the video playback device 100 to perform one or more predetermined operations according to the subtitle start time points. According to some special cases of this embodiment, such as those mentioned above, the aforementioned at least one subtitle end time point may comprise a plurality of subtitle end time points respectively corresponding to the subtitles, and/or the aforementioned at least one text string may comprise a plurality of text strings respectively corresponding to the subtitles. Thus, the processing circuit 140 controls the video playback device 100 to perform one or more predetermined operations according to the subtitle start time points, the subtitle end time points, and/or the text strings.

Please note that, based upon default settings or user settings of the video playback device 100, the user interface of the subtitle-based repeat/playback function (e.g. the aforementioned at least one physical user interface and/or the aforementioned at least one displayed user interface) can be utilized for controlling the video playback device 100 to perform at least one predetermined operation according to the above-mentioned at least one subtitle start time point in response to at least one predetermined user control activity. This is for illustrative purposes only, and is not meant to be a limitation of the present invention. According to some variations of this embodiment, based upon default settings or user settings of the video playback device 100, the processing circuit 140 may automatically control the video playback device 100 to perform the aforementioned at least one predetermined operation according to the above-mentioned at least one subtitle start time point, without being triggered by any predetermined user control activity.

According to some variations of this embodiment, the processing circuit 140 is arranged to store at least one text string (e.g. one or more text strings such as text strings Str(1), Str(2), . . . , etc.) corresponding to the aforementioned at least one subtitle (e.g. one or more subtitles such as subtitles 24-1, 24-2, . . . , etc.) into the storage unit/module mentioned above. In addition, the processing circuit 140 is further arranged to store an identification number of the storage medium 120M, such as the removable storage medium that stores contents comprising the aforementioned at least one subtitle, into the storage unit/module (e.g. the storage unit 140S of some embodiments, or a storage module such as those in some of the following embodiments). In a situation where the removable storage medium is temporarily removed from the video playback device 100, when it is detected that the removable storage medium is reloaded into the video playback device 100, the processing circuit 140 retrieves the aforementioned at least one text string (e.g. one or more text strings such as text strings Str(1), Str(2), . . . , etc.) for further use.

Thus, the processing circuit 140 is capable of keeping the user environment for the user. As a result, when the same storage medium 120M is reloaded into the video playback device 100, and more particularly, the medium accessing module 120, the user may continue to use the subtitle-based repeat/playback function, where the processing circuit 140 may continue to collect additional using behaviors of the user or operate based upon the previous using behaviors of the user. For example, the user may continue his/her learning by using the subtitle-based repeat/playback function.

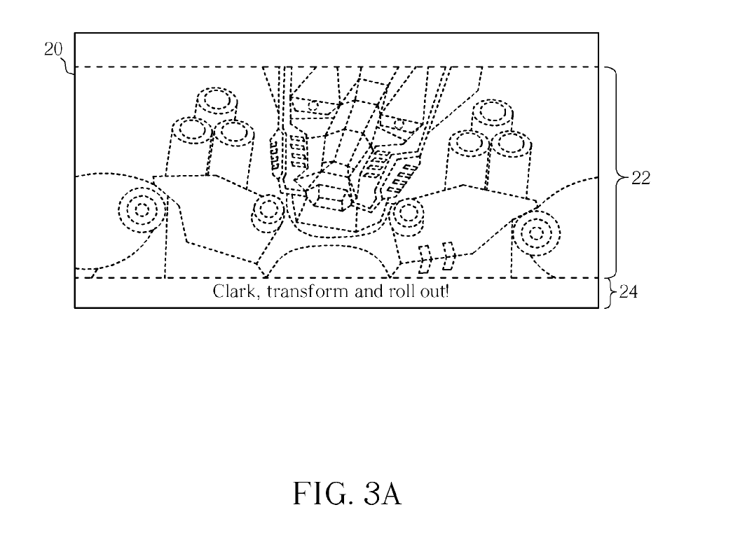

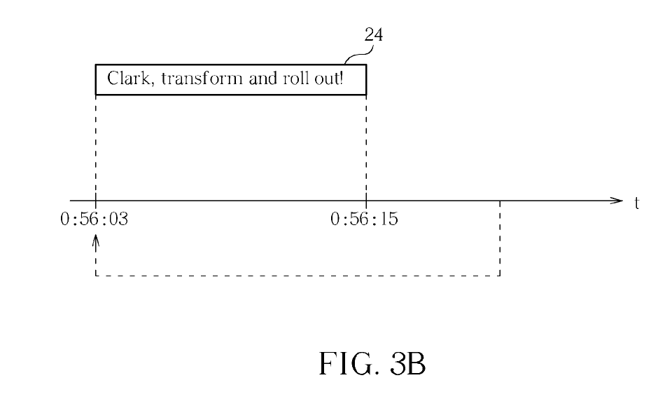

Please refer to FIG. 3A and FIG. 3B. FIG. 3A illustrates a screen 20 displaying a subtitle 24 and an associated video content 22 that are involved in the method 910 shown in FIG. 2 according to an embodiment of the present invention, where this embodiment is a special case of the embodiment shown in FIG. 2, such as one of those mentioned above. FIG. 3B illustrates a subtitle start time point and a subtitle end time point respectively corresponding to the subtitle 24 shown in FIG. 3A, where the subtitle 24 (labeled “Clark, transform and roll out!” in FIG. 3B) starts at the subtitle start time point (labeled “0:56:03” in FIG. 3B) and ends at the subtitle end time point (labeled “0:56:15” in FIG. 3B). According to this embodiment, the remote control receiver 110 stores the subtitle start time point and the subtitle end time point respectively corresponding to the subtitle 24 (e.g. the current or the latest subtitle of the program) when the user presses a predetermined key/button on the remote controller mentioned above. For example, the processing circuit 140 controls the video playback device 100 to automatically jump to the subtitle start time point (labeled “0:56:03” in FIG. 3B). In another example, when the user presses the same or another predetermined key/button on the remote controller (not shown), the remote control receiver 110 receives a remote control signal from the remote controller and therefore the processing circuit 140 detects such a predetermined user control activity, and then, the processing circuit 140 controls the video playback device 100 to jump to the subtitle start time point (labeled “0:56:03” in FIG. 3B). Thus, the aforementioned at least one predetermined operation can be triggered automatically or manually.

After jumping to the subtitle start time point, the processing circuit 140 may control the video playback device 100 to play back starting from the subtitle start time point, or repeatedly play back during the interval between the subtitle start time point and the subtitle end time point, based upon default settings or user settings of the video playback device 100. As a result, the user may have the opportunity to learn the sentence(s)/word(s) in the subtitle 24 (e.g. one or more words of the sentence “Clark, transform and roll out!” in this embodiment). Therefore, the user may enjoy learning during viewing the program, having no need to stop viewing the program.

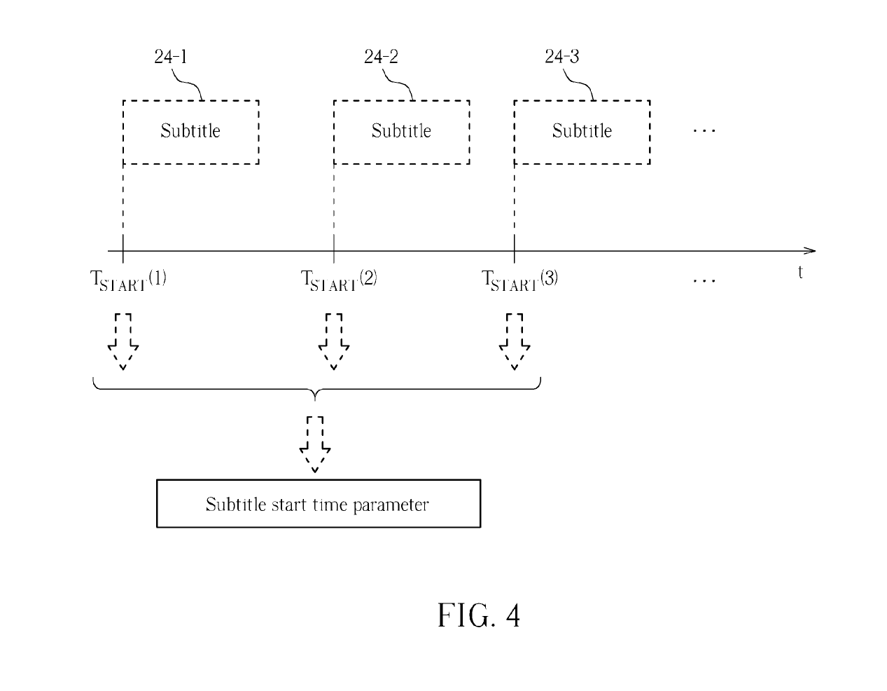

FIG. 4 illustrates a plurality of subtitles 24-1, 24-2, 24-3, . . . , etc. and a plurality of subtitle start time points T_{START}(1), T_{START}(2), T_{START}(3), . . . , etc. respectively corresponding to the subtitles 24-1, 24-2, 24-3, . . . , etc. according to an embodiment of the present invention, where this embodiment is a special case of the embodiment shown in FIG. 2. Please note that this embodiment is a variation of the embodiment shown in FIGS. 3A and 3B, and the predetermined operation can be similar to one of those disclosed in the embodiment shown in FIGS. 3A and 3B. In practice, the processing circuit 140 may temporarily store the subtitle start time points T_{START}(1), T_{START}(2), T_{START}(3), . . . , etc. as a single subtitle start time parameter in the aforementioned storage unit/module in turns. In addition, the aforementioned at least one predetermined operation can be triggered automatically or manually. Similar descriptions are not repeated in detail for this embodiment.

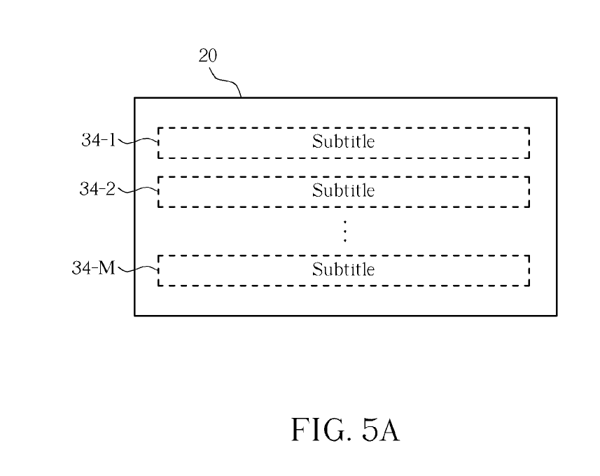

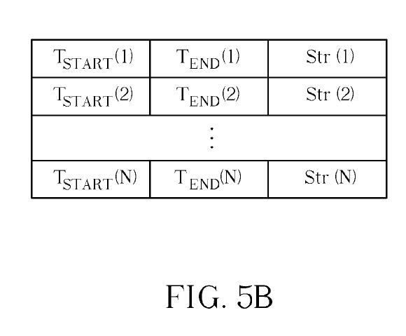

Please refer to FIG. 5A and FIG. 5B. FIG. 5A illustrates an exemplary user interface arrangement according to an embodiment of the present invention, where this embodiment is another special case of the embodiment shown in FIG. 2. FIG. 5B illustrates a plurality of subtitle start time points T_{START}(1), T_{START}(2), . . . , and T_{START}(N), a plurality of subtitle end time points T_{END}(1), T_{END}(2), . . . , and T_{END}(N), and a plurality of text strings Str(1), Str(2), . . . , and Str(N) that are involved in the method 910 shown in FIG. 2 according to the embodiment shown in FIG. 5A. Here, the processing circuit 140 is arranged to store the subtitle start time points T_{START}(1), T_{START}(2), and T_{START}(N), the subtitle end time points T_{END}(1), T_{END}(2), and T_{END}(N), and the text strings Str(1), Str(2), . . . , and Str(N) respectively corresponding to the subtitles 24-1, 24-2, . . . , and 24-N. Thus, the first row of the table shown in FIG. 5B corresponds to the subtitle 24-1, the second row of the table shown in FIG. 5B corresponds to the subtitle 24-2, . . . , and the N^{th} row of the table shown in FIG. 5B corresponds to the subtitle 24-N. Based upon user selection of at least a portion of the subtitles 24-1, 24-2, and 24-N, the processing circuit 140 is arranged to control the video playback device 100 to perform the aforementioned at least one predetermined operation, such as one or more subtitle-based repeat/playback operations of at least a portion of the program.

In practice, in a situation where the subtitles 24-1, 24-2, . . . , and 24-N comprise too many subtitles that can not be displayed within a limited height of the screen 20 (and more particularly, within a limited height of a predetermined display area of a menu) at the same time, the user interface is utilized for displaying a portion of the subtitles 24-1, 24-2, . . . , and 24-N. For example, the subtitles 34-1, 34-2, and 34-M shown in FIG. 5A represent the portion of the subtitles 24-1, 24-2, . . . , and 24-N, where M is less than N. In addition, in a situation where the subtitles 24-1, 24-2, . . . , and 24-N can be displayed within the limited height of the screen 20 (and more particularly, within the limited height of the predetermined display area of the menu) at the same time, the user interface can be utilized for displaying all of the subtitles 24-1, 24-2, . . . , and 24-N. For example, the subtitles 34-1, 34-2, and 34-M shown in FIG. 5A respectively represent the subtitles 24-1, 24-2, . . . , and 24-N, where M is equal to N.

In order to provide the user with a selection mechanism through the user interface, the aforementioned at least one predetermined operation comprises displaying at least a portion of the text strings Str(1), Str(2), . . . , and Str(N) as items of the menu. As some of the subtitles 34-1, 34-2, . . . , and 34-M may comprise too many words that can not be displayed within a limited width of the screen 20 (and more particularly, within a limited width of a predetermined display area of an idem of the menu) at the same time, a subtitle 34-m of the subtitles 34-1, 34-2, . . . , and 34-M may comprise at least a portion of a text string Str(n) (e.g. the whole text string Str(n), or a partial text string thereof), where m and n are positive integers, and m may vary within the interval [1, M]. Regarding the text string Str(n) mentioned above, the range of n may vary in different situations. For example, in a situation where the subtitles 24-1, 24-2, and 24-N are not all displayed at the same time, n may vary within a portion of the interval [1, N]. In another example, in a situation where the subtitles 24-1, 24-2, . . . , and 24-N are displayed at the same time, n may vary within the interval [1, N].

In addition, the aforementioned at least one predetermined operation further comprises playing back during at least one interval corresponding to a selected portion of the items in response to user selection regarding the selected portion, wherein each of the at least one interval is between an associated subtitle start time point T_{START}(n₀) and an associated subtitle end time point T_{END}(n₀). For example, in a situation where the user does not select all of the subtitles 24-1, 24-2, and 24-N, nₒ may vary within a portion of the interval [1, N]. In another example, in a situation where the user selects all of the subtitles 24-1, 24-2, . . . , and 24-N, n₀ may vary within the interval [1, N]. Thus, no matter whether n₀ varies within the portion of the interval [1, N] or varies within the interval [1, N], the processing circuit 140 controls the video playback device 100 to play back during one or more intervals, such as the n₀^{th} interval between the associated subtitle start time point T_{START}(n₀) and an associated subtitle end time point T_{END}(n₀).

According to a variation of the embodiment shown in FIGS. 5A and 58, in order to perform the subtitle-based repeat/playback operation(s) of at least a portion of the program, the processing circuit 140 can automatically select one or more intervals, such as the n₀^{th} interval between the associated subtitle start time point T_{START}(n₀) and an associated subtitle end time point T_{END}(n₀), based upon default settings or user settings of the video playback device 100. Similar descriptions are not repeated in detail for this variation.

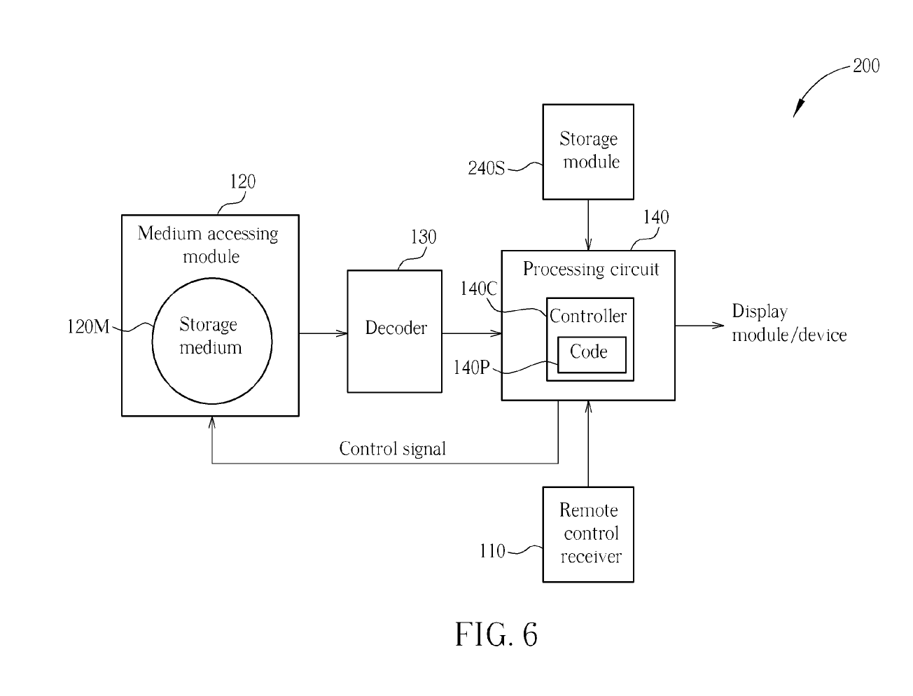

FIG. 6 is a diagram of a video playback device 200 provided with a subtitle-based repeat/playback function according to a second embodiment of the present invention. This embodiment is a variation of the first embodiment, Here, the aforementioned at least one storage unit/module comprises the storage module 240S. In particular, the storage unit 140S shown in FIG. 1 is replaced by the storage module 240S in this embodiment. Similar descriptions are not repeated in detail for this embodiment.

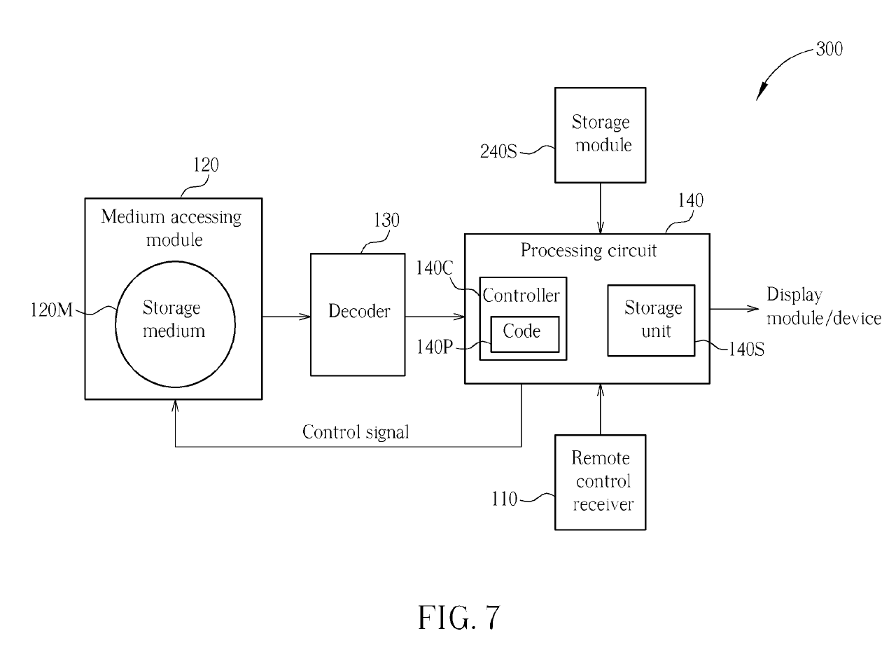

FIG. 7 is a diagram of a video playback device 300 provided with a subtitle-based repeat/playback function according to a third embodiment of the present invention. This embodiment is a variation of the first embodiment, and is a variation of the second embodiment. Here, the aforementioned at least one storage unit/module comprises the storage unit 140S shown in FIG. 1 and the storage module 240S shown in FIG. 6. For example, a portion of the aforementioned at least one subtitle start time point (e.g. the subtitle start time points T_{START}(1), T_{START}(2), . . . , etc.), the aforementioned at least one subtitle end time point (e.g. the subtitle end time points T_{END}(1), T_{END}(2), . . . , etc.), the aforementioned at least one text string (e.g. the text strings Str(1), Str(2), etc.), and/or the identification number of the storage medium 120M can be stored in the storage unit 140S, while another portion (or the other portion) of them can be stored in the storage module 240S. Similar descriptions are not repeated in detail for this embodiment.

It is an advantage of the present invention that the present invention method and the associated video playback device can provide the user interface of the subtitle-based repeat/playback function for controlling the video playback device to perform at least one predetermined operation according to the at least one subtitle start time point in response to at least one predetermined user control activity. As a result of the aforementioned at least one predetermined operation, such as the subtitle-based repeat/playback operations disclosed in the embodiments, the user can use the video playback device with ease, and the related art problems such as those mentioned above will never occur.

Those skilled in the art will readily observe that numerous modifications and alterations of the device and method may be made while retaining the teachings of the invention.

1. A method for providing a video playback device with a subtitle-based repeat/playback function, the method comprising:
storing at least one subtitle start time point corresponding to at least one subtitle; and
providing the video playback device with a user interface for controlling the video playback device to perform at least one predetermined operation according to the at least one subtitle start time point in response to at least one predetermined user control activity.

2. The method of claim 1, wherein the at least one predetermined operation comprises jumping to the subtitle start time point.

3. The method of claim 2, further comprising:
storing at least one subtitle end time point corresponding to the at least one subtitle.

4. The method of claim 3, wherein the predetermined operation comprises repeatedly playing back during an interval between the subtitle start time point and the subtitle end time point.

5. The method of claim 2, wherein the predetermined operation comprises playing back starting from the subtitle start time point.

6. The method of claim 1, further comprising:
storing at least one text string corresponding to the at least one subtitle.

7. The method of claim 6, further comprising:
storing an identification number of a removable storage medium that stores contents comprising the at least one subtitle; and
in a situation where the removable storage medium is temporarily removed from the video playback device, when it is detected that the removable storage medium is reloaded into the video playback device, retrieving the at least one text string for further use.

8. The method of claim 6, further comprising:
performing a translation operation on the at least one subtitle to generate the at least one text string.

9. The method of claim 6, wherein the at least one subtitle comprises a plurality of subtitles, the at least one subtitle start time point comprises a plurality of subtitle start time points respectively corresponding to the subtitles, and the at least one text string comprises a plurality of text strings respectively corresponding to the subtitles; and the method further comprises:
storing a plurality of subtitle end time points respectively corresponding to the subtitles.

10. The method of claim 9, wherein the at least one predetermined operation comprises:
displaying at least a portion of the text strings as items of a menu; and
playing back during at least one interval corresponding to a selected portion of the items in response to user selection regarding the selected portion, wherein each of the at least one interval is between an associated subtitle start time point and an associated subtitle end time point.

11. A video playback device provided with a subtitle-based repeat/playback function, the video playback device comprising:
at least one storage unit/module arranged to store information; and
a processing circuit arranged to store at least one subtitle start time point corresponding to at least one subtitle into the storage unit/module, wherein the processing circuit is further arranged to provide the video playback device with a user interface for controlling the video playback device to perform at least one predetermined operation according to the at least one subtitle start time point in response to at least one predetermined user control activity;
wherein the storage unit/module is embedded in the processing circuit or positioned outside the processing circuit.

12. The video playback device of claim 11, wherein the at least one predetermined operation comprises jumping to the subtitle start time point.

13. The video playback device of claim 12, wherein the processing circuit is further arranged to store at least one subtitle end time point corresponding to the at least one subtitle into the storage unit/module.

14. The video playback device of claim 13, wherein the predetermined operation comprises repeatedly playing back during an interval between the subtitle start time point and the subtitle end time point.

15. The video playback device of claim 12, wherein the predetermined operation comprises playing back starting from the subtitle start time point.

16. The video playback device of claim 11, wherein the processing circuit is further arranged to store at least one text string corresponding to the at least one subtitle into the storage unit/module.

17. The video playback device of claim 16, wherein the processing circuit is further arranged to store an identification number of a removable storage medium that stores contents comprising the at least one subtitle into the storage unit/module; and in a situation where the removable storage medium is temporarily removed from the video playback device, when it is detected that the removable storage medium is reloaded into the video playback device, the processing circuit retrieves the at least one text string for further use.

18. The video playback device of claim 16, wherein the processing circuit performs a translation operation on the at least one subtitle to generate the at least one text string.

19. The video playback device of claim 16, wherein the at least one subtitle comprises a plurality of subtitles, the at least one subtitle start time point comprises a plurality of subtitle start time points respectively corresponding to the subtitles, and the at least one text string comprises a plurality of text strings respectively corresponding to the subtitles; and the processing circuit is further arranged to store a plurality of subtitle end time points respectively corresponding to the subtitles into the storage unit/module.

20. The video playback device of claim 19, wherein the at least one predetermined operation comprises:
displaying at least a portion of the text strings as items of a menu; and
playing back during at least one interval corresponding to a selected portion of the items in response to user selection regarding the selected portion, wherein each of the at least one interval is between an associated subtitle start time point and an associated subtitle end time point.

21. A processing circuit for controlling a video playback device and providing the video playback device with a subtitle-based repeat/playback function, the processing circuit comprising:
a controller arranged to control operations of the video playback device; and
a program code embedded in the controller or received from outside the controller, wherein the controller executing the program code is arranged to store at least one subtitle start time point corresponding to at least one subtitle into at least one storage unit/module within the video playback device, and is further arranged to provide the video playback device with a user interface for controlling the video playback device to perform at least one predetermined operation according to the at least one subtitle start time point in response to at least one predetermined user control activity.

22. The processing circuit of claim 21, wherein the at least one predetermined operation comprises jumping to the subtitle start time point.

23. The processing circuit of claim 22, wherein the processing circuit is further arranged to store at least one subtitle end time point corresponding to the at least one subtitle into the storage unit/module.

24. The processing circuit of claim 23, wherein the predetermined operation comprises repeatedly playing back during an interval between the subtitle start time point and the subtitle end time point.

25. The processing circuit of claim 22, wherein the predetermined operation comprises playing back starting from the subtitle start time point.

26. The processing circuit of claim 21, wherein the processing circuit is further arranged to store at least one text string corresponding to the at least one subtitle into the storage unit/module.

27. The processing circuit of claim 26, wherein the processing circuit is further arranged to store an identification number of a removable storage medium that stores contents comprising the at least one subtitle into the storage unit/module; and in a situation where the removable storage medium is temporarily removed from the video playback device, when it is detected that the removable storage medium is reloaded into the video playback device, the processing circuit retrieves the at least one text string for further use.

28. The processing circuit of claim 26, wherein the processing circuit performs a translation operation on the at least one subtitle to generate the at least one text string.

29. The processing circuit of claim 26, wherein the at least one subtitle comprises a plurality of subtitles, the at least one subtitle start time point comprises a plurality of subtitle start time points respectively corresponding to the subtitles, and the at least one text string comprises a plurality of text strings respectively corresponding to the subtitles; and the processing circuit is further arranged to store a plurality of subtitle end time points respectively corresponding to the subtitles into the storage unit/module.

30. The processing circuit of claim 29, wherein the at least one predetermined operation comprises:
displaying at least a portion of the text strings as items of a menu; and
playing back during at least one interval corresponding to a selected portion of the items in response to user selection regarding the selected portion, wherein each of the at least one interval is between an associated subtitle start time point and an associated subtitle end time point.
